(19) United States
(12) Patent Application Publication
(10) Pub. No.: US 2025/0080983 A1
(43) Pub. Date: Mar. 6, 2025

(54) METHOD FOR LOW-POWER ENCRYPTION SECURE WIRELESS COMMUNICATION IN ADVERTISING BROADCAST COMMUNICATION FOR BLUETOOTH LOW ENERGY (BLE)

(71) Applicant: 3A Logics Inc., Gyeonggi-do (KR)

(72) Inventors: Min Jae JEON, Gyeonggi-do (KR); Jun Ho KIM, Seoul (KR)

(21) Appl. No.: 18/757,792

(22) Filed: Jun. 28, 2024

(30) Foreign Application Priority Data
Aug. 30, 2023 (KR) 10-2023-0114361

(51) Int. Cl. H04W 12/106; H04W 12/03; H04W 12/043

(52) U.S. Cl. CPC H04W 12/106; H04W 12/03; H04W 12/043

(57) ABSTRACT

The present specification relates to a method of encrypting, by a wireless device, a data packet in advertising broadcast communication for Bluetooth low energy (BLE). The method includes: acquiring a preset unique identifier (ID) and user data, the data packet including an advertising address, a header, the unique ID, a sort ID, and the user data; encrypting the unique ID and the user data; generating a message authentication code (MAC); and generating an encrypted data packet, the encrypted data packet including the encrypted unique ID, the encrypted user data, and the MAC.

### CROSS-REFERENCE TO RELATED APPLICATION

This application claims priority to and the benefit of Korean Patent Application No. 2023-0114361, filed on Aug. 30, 2023, the disclosure of which is incorporated herein by reference in its entirety.

### BACKGROUND

### 1. Field of the Invention

The present invention relates to a method of low-power encryption secure wireless communication in advertising broadcast communication for a Bluetooth low energy (BLE) device.

### 2. Discussion of Related Art

Bluetooth advertising is a mobile marketing method that uses a Bluetooth low energy (BLE) technology to transmit content to wireless devices. Typically, the content is transmitted in a beacon over an insecure channel and may be received by wireless devices equipped with a BLE scanner.

Beacons are wireless communication technologies that transmit or receive information to peripheral digital devices. The beacons are mainly used to interact with various devices through wireless communication and transmit and receive location information, state information, advertisements, etc. For example, the beacons may be connected to peripheral smartphones, tablets, computers, etc., to implement various applications.

The beacons usually operate using the BLE, and the peripheral devices may detect signals transmitted from the beacons and perform appropriate operations accordingly. The beacons may receive signals only when peripheral devices are positioned within a predetermined distance, and thus, may be usefully used for location-based services, proximity notifications, etc.

Since beacon communication through a BLE protocol is not encrypted, the beacon communication may be exposed to various cyber threats. An example of one of these threats is unauthorized tracking. Accordingly, a broadcast identifier (ID) of the beacon may be read by nearby receivers. In this case, attackers or hackers may analyze the beacons. As another example, the attackers or hackers may forge advertising packets of the beacons that broadcast consistent IDs. This is also called spoofing, and may disguise signals that come from unknown sources as if signals come from known, trusted sources. The spoofing may be used to access target's personal information, spread malicious software through infected links or attached files, bypass network access controls, or perform denial-of-service attacks.

### SUMMARY OF THE INVENTION

The present invention is directed to providing a method of encrypting an advertising packet that does not require a Bluetooth low energy (BLE) connecting procedure.

Objects of the present specification are not limited to the above-described objects. That is, other objects that are not mentioned may be obviously understood by those skilled in the art to which the present specification pertains from the following description.

According to an aspect of the present invention, there is provided a method of encrypting, by a wireless device, a data packet in advertising broadcast communication for Bluetooth low energy (BLE), including: acquiring a preset unique identifier (ID) and user data, the data packet including an advertising address, a header, the unique ID, a sort ID, and the user data; encrypting the unique ID and the user data; generating a message authentication code (MAC); and generating an encrypted data packet, the encrypted data packet including the encrypted unique ID, the encrypted user data, and the MAC.

The encrypting of the unique ID and the user data may include: extracting an indexed encryption key based on the sort ID; and encrypting the unique ID based on the indexed encryption key.

The encrypting of the unique ID may be performed using a counter (CTR) mode.

The encrypting of the unique ID and the user data may include: inspecting whether a length of the user data is a multiple of 16 bytes; and encrypting the user data based on the inspection.

In the encrypting of the user data based on the inspection, when the length of the user data is a multiple of 16 bytes, the user data may be encrypted using an electronic codebook (ECB) mode based on the unique ID.

In the encrypting of the user data based on the inspection, when the length of the user data is smaller than 16 bytes, the user data may be encrypted using a CTR mode based on the unique ID.

The encrypting of the user data based on the inspection may include: dividing the user data into a first part having a length value that is a multiple of 16 bytes and a second part that is a remaining part when the length of the user data is greater than a multiple of 16 bytes; encrypting the first part using an ECB mode based on the unique ID; and encrypting the second part using a CTR mode based on the unique ID.

In the generating of the MAC is generated based on the header, the MAC may be generated based on the header, the encrypted unique ID, the sort ID, the encrypted first part, and the encrypted second part.

The method may further include performing the advertising broadcast communication for BLE using the encrypted data packet.

According to another aspect of the present invention, there is provided a wireless device for encrypting a data packet in advertising broadcast communication for Bluetooth low energy (BLE), including: a memory; and a processor that controls the memory, in which the processor may acquire a preset unique identifier (ID) and user data from the memory, the data packet including an advertising address, a header, a unique ID, a sort ID, and the user data, encrypt the unique ID and the user data, generate a message authentication code (MAC), and generate an encrypted data packet that includes the encrypted unique ID, the encrypted user data, and the MAC.

A method of decrypting, by a server, an encrypted data packet in advertising broadcast communication for Bluetooth low energy (BLE) may include: receiving the encrypted data packet, the encrypted data packet including an encrypted unique ID, encrypted user data, and a message authentication code (MAC); verifying the MAC; and decrypting the data packet based on a fact that the MAC is valid.

### BRIEF DESCRIPTION OF THE DRAWINGS

The above and other objects, features and advantages of the present invention will become more apparent to those of ordinary skill in the art by describing exemplary embodiments thereof in detail with reference to the accompanying drawings, in which:

FIG. 1 is a schematic diagram illustrating an example of a wireless communication system using a Bluetooth low energy (BLE) technology proposed in the present specification;

FIG. 2 is a diagram illustrating an example of an internal block diagram of a device that may implement the methods proposed in the present specification;

FIGS. 3A and 3B are diagrams illustrating an example of Bluetooth communication architecture to which the methods proposed in the present specification may be applied;

FIG. 4 is a flowchart illustrating a method of forming a connection using BLE between devices;

FIG. 5 is a diagram illustrating encryption of a beacon protocol that may be applied in the present specification;

FIG. 6 is a diagram illustrating a packet format of an LE device to which the present specification may be applied;

FIG. 7 is a diagram illustrating a method of securing a data packet that may be applied in the present specification;

FIG. 8 is a diagram illustrating an embodiment of a wireless device to which the present specification may be applied; and

FIG. 9 is a diagram illustrating an embodiment of a server to which the present specification may be applied.

### DETAILED DESCRIPTION OF EXEMPLARY EMBODIMENTS

Objects, features, and advantages of the present specification will become more obvious from the following detailed description provided in relation to the accompanying drawings. However, the present specification may be variously modified and have several exemplary embodiments. Hereinafter, specific exemplary embodiments of the present specification will be illustrated in the accompanying drawings and be described in detail. In principle, same reference numerals denote same constituent elements throughout the specification. In addition, when it is determined that a detailed description for the known functions or configurations related to the present specification may obscure the gist of the present specification, detailed descriptions thereof will be omitted.

Hereinafter, a method and device related to the present specification will be described in more detail with reference to the drawings. In addition, the terms “module” and “unit” for components used in the following description are used only to easily make the specification. Therefore, these terms do not have meanings or roles that distinguish from each other in themselves.

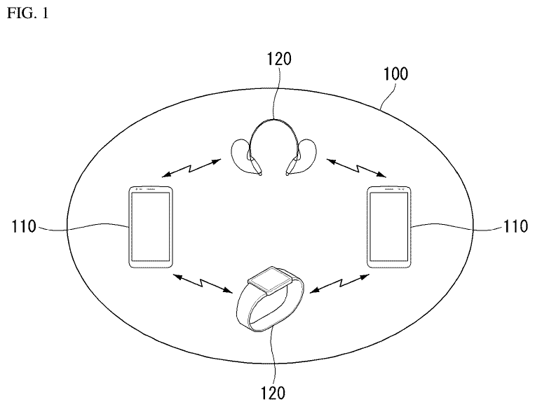

FIG. 1 is a schematic diagram illustrating an example of a wireless communication system using a Bluetooth low energy technology proposed in the present specification.

A wireless communication system 100 includes at least one server device 120 and at least one client device 110.

The server device and the client device perform Bluetooth communication using a Bluetooth low energy (hereinafter referred to as ‘BLE’ for convenience) technology.

First, compared to Bluetooth basic rate/enhanced data rate (Bluetooth BR/EDR) technology, the BLE technology may have a relatively small duty cycle, may be produced at a low price, and may significantly reduce power consumption through a low-speed data transmission rate to operate a coin cell battery for a year or longer.

In addition, in the BLE technology, a connecting procedure between devices is simplified, and a packet size is also designed to be smaller than that of Bluetooth BR/EDR technology.

The server device 120 may operate as a client device in the relationship with other devices, and the client device may operate as a server device in the relationship with other devices. That is, in a BLE communication system, any one device can operate as a server device or a client device, and if necessary, operate as the server device and the client device simultaneously.

The server device 120 may be expressed as a data service device, a slave device, a slave, a server, a conductor, a host device, a gateway, and a sensing device, a monitoring device, a first device, a first data logger, etc., and the client device 110 may be expressed as a master device, a master, a client, a member, a sensor device, a sink device, a collector, a second device, a second data logger, etc.

The server device and the client device correspond to main components of the wireless communication system, and the wireless communication system may include other components in addition to the server device and the client device.

The server device is a device that receives data from a client device, communicates directly with the client device, and provides data to the client device through a response upon receiving a data request from the client device.

In addition, the server device transmits a notification message and an indication message to the client device to provide data information to the client device. In addition, when the server device transmits the indication message to the client device, the server device receives a confirm message corresponding to the indication message from the client.

In addition, the server device may provide data information to a user through a display unit or receive a request input from the user through the user input interface while transmitting and receiving notifications, indications, and confirm messages to and from the client device.

In addition, the server device may read data from a memory unit or write new data to the memory unit while transmitting and receiving messages to and from the client device.

In addition, one server device may be connected to a plurality of client devices, and easily reconnected to (or access) the client devices using bonding information.

The client device 110 is a device that requests data information and data transmission from the server device.

The client device receives data through the notification message, the indication message, etc., from the server device, and transmits the confirm message in response to the indication message upon receiving the indication message from the server device.

Similarly, the client device may also provide information to a user through the display unit or receive input from the user through the user input interface while transmitting and receiving the messages to and from the server device.

In addition, the client device may read data from a memory unit or write new data to the memory unit while transmitting and receiving messages to and from the server device.

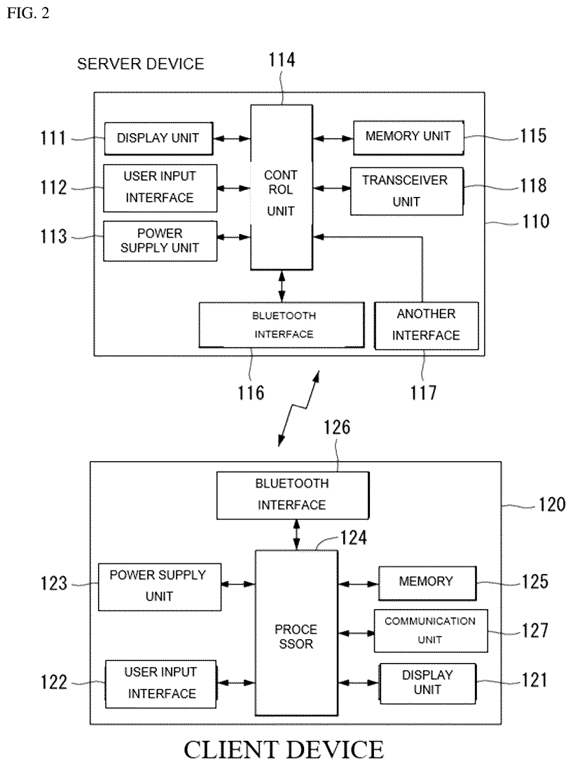

Hardware components such as the display unit, the user input interface, and the memory unit of the server device and the client device will be described in detail with reference to FIG. 2.

In addition, the wireless communication system may establish personal area networking (PAN) through Bluetooth technology. For example, in the wireless communication system, files, documents, etc., may be exchanged quickly and safely by establishing a private piconet between the devices.

FIG. 2 is a diagram illustrating an example of an internal block diagram of a device that may implement the methods proposed in the present specification.

As illustrated in FIG. 2, the server device includes a display unit 111, a user input interface 112, a power supply unit 113, a processor 114, a memory unit 115, a Bluetooth interface 116, a different communication interface 117, and a communication unit (or transceiver unit) 118.

The display unit 111, the user input interface 112, the power supply unit 113, the processor 114, the memory unit 115, the Bluetooth interface 116, the different communication interface 117, and the communication unit 118 are functionally connected to perform the methods proposed in the present specification.

In addition, the client device includes a display unit 121, a user input interface 122, a power supply unit 123, a processor 124, a memory unit 125, a Bluetooth interface 126, and a communication unit (or transceiver unit) 127.

The display unit 121, the user input interface 122, the power supply unit 123, the processor 124, the memory unit 125, the Bluetooth interface 126, and the communication unit 118 are functionally connected to perform the methods proposed in the present specification.

The Bluetooth interfaces 116 and 126 are units (or modules) capable of transmitting requests/responses, commands, notifications, indications/confirm messages, etc., or data between the devices using the Bluetooth technology.

The memory units 115 and 125 are units implemented in various types of devices and refer to units in which various types of data are stored.

The processors 114 and 124 are modules that control the overall operation of the server device or client device, and perform control so that a transmission request of messages and received messages through the Bluetooth interface and the different communication interface are processed.

The processors 114 and 124 may be expressed as a control part, a control unit, a controller, etc.

The processors 114 and124 may include an application-specific integrated circuit (ASIC), other chipsets, logic circuits, and/or data processing devices.

The processors 114 and 124 control the communication unit to receive advertising messages from the server device, transmit a scan request message to the server device, control the communication unit to receive a scan response message in response to the scan request from the server device, and controls the communication unit to transmit a connect request message to the server device to establish a Bluetooth connection with the server device.

In addition, the processors 114 and 124 control the communication unit to read or write data using an ATT from the server device after a BLE connection is formed through the connecting procedure.

The memory units 115 and 125 may include a read-only memory (ROM), a random access memory (RAM), a flash memory unit, a memory unit card, a storage medium, and/or other storage devices.

The communication units 118 and 127 may include a baseband circuit for processing wireless signals. When the embodiment is implemented in software, the above-described technique may be implemented as a module (process, function, etc.) performing the above-described function. The module is stored in the memory unit and may be executed by the processor.

The memory units 115 and 125 may be disposed inside or outside the processors 114 and 124 and connected to the processors 114 and 124 by various well-known means.

The display units 111 and 121 are modules for providing device state information, message exchange information, etc., to a user through a screen.

The power supply units 113 and 123 are modules that receive external power and internal power under the control of the control unit and supply power necessary for the operation of each component.

As described above, the BLE technology has a small duty cycle and may significantly reduce power consumption through a low data transmission rate, and the power supply unit may supply power required for the operation of each component even with low output power (10 mW (10 dBm) or less).

The user input interfaces 112 and 122 are modules that allow a user to control the operation of the device by providing user input, such as a screen button, to the control unit.

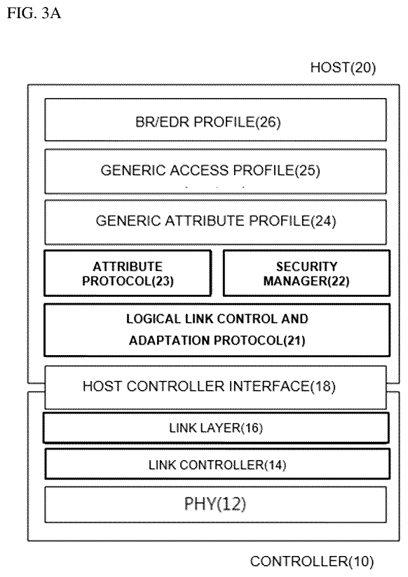

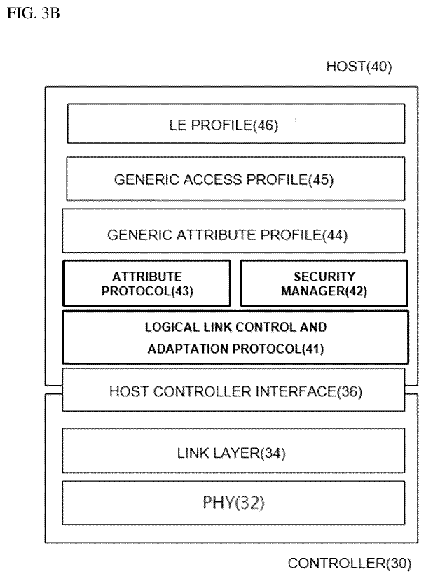

FIGS. 3A and 3B are diagrams illustrating an example of Bluetooth communication architecture to which the methods proposed in the present specification may be applied.

Referring to FIGS. 3A and 3B, FIG. 3A illustrates an example of a Bluetooth basic rate (BR)/enhanced data rate (EDR) protocol stack, and FIG. 3B represents an example of a BLE protocol stack.

Specifically, as illustrated in FIG. 3A, the Bluetooth BR/EDR protocol stack may include an upper controller stack 10 and a lower host stack 20 based on a host controller interface (HCl) 18.

The host stack (or host module) 20 refers to a wireless transceiver module that receives a 2.4 GHz Bluetooth signal and hardware for transmitting or receiving Bluetooth packets, and is connected to the Bluetooth module, which is the controller stack 10, to perform an operation of controlling the Bluetooth module.

The host stack 20 may include a Bluetooth basic rate/enhanced data rate physical (BR/EDR PHY) 12, a BR/EDR baseband layer 14, and a link manager layer 16.

The BR/EDR PHY layer 12 is a layer that transmits and receives 2.4 GHz wireless signals, and when using Gaussian frequency shift keying (GFSK) modulation, may transmit data by hopping 79 RF channels.

The BR/EDR baseband layer 14 is responsible for transmitting digital signals, selects a channel sequence that hops 1400 times per second, and transmits a time slot of 625 μs for each channel.

The link manager layer 16 uses a link manager protocol (LMP) to control the overall operations (link setup, control, security) of the Bluetooth connection. The link manager layer 16 may perform the following functions.
Perform asynchronous connectionless link (ACL)/synchronous connection-oriented (SCO) logical transport, logical link setup, and control.
Detach: Stop the connection and informs other devices of the reason for the stop.
Perform power control and role switch.
Perform security (authentication, pairing, encryption) functions.

The host controller interface layer 18 may provide an interface between the host module and the controller module to allow the host to provide commands and data to the controller and the controller to provide events and data to the host.

The host stack (or host module, 20) includes a logical link control and adaptation protocol (L2CAP) 21, a security manager (SM) 22, an attribute protocol (ATT) 23, a generic attribute profile (GATT) 24, a generic access profile (GAP) 25, and a BR/EDR profile 26.

The L2CAP 21 may provide one two-way channel for transmitting data to a specific protocol or a profile.

The L2CAP 21 is capable of multiplexing various protocols, profiles, etc., provided on Bluetooth.

The L2CAP of the Bluetooth BR/EDR uses a dynamic channel, supports a protocol service multiplexer, a retransmission, and a streaming mode, and provides segmentation and reassembly, per-channel flow control, and error control.

The SM 22 is a protocol for authenticating devices and providing key distribution.

The GATT 24 can operate as a protocol that describes how the ATT 23 is used when configuring services. For example, the GATT 24 can operate to specify how the ATT attributes are grouped together into services and operate to describe features linked with the services.

Accordingly, the GATT 24 and the ATT 23 may use features to describe the state and services of the devices, how the features are associated with each other and how the features are used.

The ATT 23 and profile 26 define a service (profile) using the Bluetooth BR/EDR and an application protocol for exchanging the data, and the GAP 25 defines a method of device discovery, connection, and provision of information to a user, and provides privacy.

As illustrated in FIG. 3B, the BLE protocol stack includes a controller stack 30 that can operate to process a timing-critical wireless device interface and a host stack 40 that can operate to process high level data.

First, the controller stack 30 may be implemented using a communication module that may include a Bluetooth wireless device, for example, a processor module that may include a processing device such as a microprocessor.

The host stack may be implemented as part of an operating system (OS) running on a processor module, or as an instantiation of a package on the OS.

In some instances, the controller stack and host stack may operate or execute on the same processing device within the processor module.

The controller stack 30 includes a PHY 32, a link layer (LL) 34, and an HCl 36.

The PHY (wireless transceiver module) 32 is a layer that transmits and receives 2.4 GHz wireless signals and uses a frequency hopping technique that includes GFSK modulation and 40 RF channels.

The LL 34, which serves to transmit or receive Bluetooth packets, provides a function of performing advertising and scanning functions using three advertising channels, generating a connection between devices, and then transmitting and receiving data packets of up to 257 bytes through 37 data channels.

The host stack includes a GAP 40, an L2CAP 41, an SM 42, an ATT 440, and a GATT 44, a GAP 25, and an LT profile 46. However, the host stack 40 is not limited thereto and may include various protocols and profiles.

The host stack uses the L2CAP to multiplex various protocols and profiles provided on Bluetooth.

First, the L2CAP 41 may provide one two-way channel for transmitting data to a specific protocol or profile.

The L2CAP 41 can operate to multiplex data between upper layer protocols, segment and reassemble packages, and manage multicast data transmission.

The BLE uses three fixed channels (one for signaling CH, one for SM, and one for ATT).

On the other hand, the BR/EDR uses the dynamic channel and supports the protocol service multiplexer, the retransmission, the streaming mode, etc.

The SM 42 is a protocol for authenticating devices and providing key distribution.

The ATT 43 defines rules for accessing data of the other device in a server-client structure. The ATT has the following six message types (request, response, command, notification, indication, and confirmation).
\textcircled{1} Request and response messages: Request message is a message to request specific information from a client device to a server device, and a response message is a response message to the request message and is a message transmitted from the server device to the client device.
\textcircled{2} Command message: Message transmitted from the client device to the server device to indicate a command for a specific operation. The server device does not transmit a response to the command message to the client device.
\textcircled{3} Notification message: Message transmitted from the server device to the client device for notification of events, etc. The client device does not transmit the confirm message for the notification message to the server device.
\textcircled{4} Indication and confirm message: Message transmitted from the server device to the client device for notification of events, etc. Unlike the notification message, the client device transmits the confirm message for the indication message to the server device.

This specification may transmit a value for a data length when requesting long data in the GATT profile using the ATT 43 to allow the client to clearly know the data length, and use a universally unique identifier (UUID) to acquire characteristic values information from the server.

The GAP 45 is a newly implemented layer for the BLE technology and is used to control role selection for communication between the BLE devices and how multi-profile operation occurs.

In addition, the GAP 45 is mainly used in device discovery, connection generation, and security procedure, defines a method of providing information to a user, and defines types of attributes as follows.
\textcircled{1} Service: Defines a basic operation of the device as a combination of data-related behaviors
\textcircled{2} Include: Defines the relationship between services
\textcircled{3} Characteristics: Data values used in services
\textcircled{4} Behavior: Computer-readable format defined as UUID (value type)

The LE profiles 46 are profiles dependent on the GATT and are mainly applied to BLE devices. The LE profile 46 may include, for example, battery, time, FindMe, proximity, time, object delivery service, etc., and the specific contents of GATT-based profiles are as follows.
\textcircled{1} Battery: Method of exchanging battery information
\textcircled{2} Time: Method of exchanging time information
\textcircled{3} FindMe: Provides an alarm service based on distance
\textcircled{4} Proximity: Method of exchanging battery information
\textcircled{5} Time: Method of exchanging time information

The GATT 44 can operate as a protocol that describes how the ATT 43 is used when configuring services. For example, the GATT 44 can operate to specify how the ATT attributes are grouped together into services and operate to describe features linked with the services.

Accordingly, the GATT 44 and the ATT 43 may use features to describe the state and services of the devices, how the features are associated with each other and how the features are used.

Hereinafter, the procedures of the BLE technology will be briefly described.

The BLE procedure may be divided into a device filtering procedure, an advertising procedure, a scanning procedure, a discovering procedure, a connecting procedure, etc.

### Device Filtering Procedure

The device filtering procedure is a method of reducing the number of devices that performs a response to request, indication, notification, etc., in a controller stack.

When the request is received from all devices, it is not necessary to respond to the request, so the controller stack may perform control so that power consumption is reduced in the BLE controller stack by reducing the number of transmitted requests.

An advertising device or scanning device may perform the device filtering procedure to limit devices that receive advertising packets, scan requests, or connection requests.

Here, the advertising device is a device that transmits advertising events, that is, performs advertising, and is also expressed as an advertiser.

The scanning device is a device that performs scanning or a device that transmits a scan request.

In the BLE, when the scanning device receives some advertising packets from the advertising device, the scanning device should transmit the scan request to the advertising device.

However, when the device filtering procedure is used and the transmission of the scan request is unnecessary, the scanning device may ignore the advertising packets transmitted from the advertising device.

The device filtering procedure may be used even in the connection request process. When the device filtering is used in the connection request process, there is no need to transmit the response to the connection request by ignoring the connection request.

### Advertising Procedure

The advertising device performs an advertising procedure to perform a non-directional broadcast to devices within an area.

Here, the non-directional broadcast is broadcast in omni (all) direction rather than broadcast in a specific direction.

In contrast, the directional broadcast is broadcast in a specific direction. The non-directional broadcast occurs without a connecting procedure between the advertising device and a device in a listening (or hearing) state (hereinafter referred to as a listening device).

The advertising procedure is used to establish a Bluetooth connection with a nearby initiating device.

Alternatively, the advertising procedure may be used to provide periodic broadcasts of user data to the scanning devices that are listening on the advertising channel.

In the advertising procedure, all advertisements (or advertising events) are broadcast through an advertising physical channel.

The advertising devices may receive the scan request from the listening devices that are listening to obtain additional user data from the advertising device. The advertising device transmits the response to the scan request to the device that transmits the scan request through the same advertising physical channel as the advertising physical channel that receives the scan request.

Broadcast user data transmitted as part of the advertising packets is dynamic data, whereas the scan response data is generally static data.

The advertising device may receive the connection request from the initiating device on the advertising (broadcast) physical channel. When the advertising device uses a connectable advertising event and the initiating device is not filtered by the device filtering procedure, the advertising device stops advertising and enters a connection mode. The advertising device may start advertising again after entering the connection mode.

### Scanning Procedure

The device that performs scanning, that is, the scanning device, performs the scanning procedure to listen to the non-directional broadcast of the user data from the advertising devices using the advertising physical channel.

The scanning device transmits the scan request to the advertising device through the advertising physical channel to request additional user data from the advertising device. The advertising device transmits the scan response, which is the response to the scan request, including additional user data requested by the scanning device through the advertising physical channel.

The scanning procedure may be used while connected to other BLE devices in a BLE piconet.

When the scanning device receives a broadcasted advertising event and is in an initiator mode that may initiate the connection request, the scanning device transmits the connection request to the advertising device through the advertising physical channel, thereby starting a Bluetooth connection with the advertising device.

When the scanning device transmits the connection request to the advertising device, the scanning device stops scanning the initiator mode for additional broadcast and enters the connection mode.

### Discovering Procedure

Devices (hereinafter referred to as ‘Bluetooth devices’) capable of Bluetooth communication perform the advertising and scanning procedures to discover devices existing nearby or to be discovered by other devices within a given area.

The discovering procedure is performed asymmetrically. The Bluetooth device that tries to find other devices existing nearby is referred to as a discovering device, and listens to find devices that advertise scannable advertising events. The Bluetooth device that can be discovered and used by other devices is called a discoverable device, and actively broadcasts the advertising event so that other devices can scan the advertising event through the advertising (broadcast) physical channel.

Both the discovering device and the discoverable device may already be connected to other Bluetooth devices in the piconet.

### Connecting Procedure

The connecting procedure is asymmetric, and the connecting procedure requires a specific Bluetooth device to perform the advertising procedure while other Bluetooth devices perform the scanning procedure.

That is, the advertising procedure may be an objective, and as a result, only one device will respond to the advertising. After receiving the connectable advertising event from the advertising device, the connection may be initiated by transmitting the connection request to the advertising device through the advertising (broadcast) physical channel.

Next, the operation state in the BLE technology, that is, the advertising state, the scanning state, the initiating state, and the connection state will be briefly described.

### Advertising State

The LL enters the advertising state by the indication of the host (stack). When the LL is in the advertising state, the LL transmits advertising packet data units in the advertising events.

Each advertising event is composed of at least one advertising PDU, and the advertising PDUs are transmitted through advertising channel indices used. The advertising event may be terminated when each advertising PDU is transmitted through the advertising channel indices used, or the advertising event may be terminated earlier when the advertising device needs to secure a space to perform other functions.

### Scanning State

The LL enters the advertising state by the indication of the host (stack). In the scanning state, the LL listens to the advertising channel indices.

There are two types of scanning states: passive scanning and active scanning. Each scanning type is determined by the host.

No separate time or advertising channel index is defined for performing the scanning.

During the scanning state, the LL listens to the advertising channel index in a scan Window duration. ScanInterval is defined as an interval between starting points of two consecutive scan windows.

The LL should perform listening for the completion of all scan intervals of the scan window as indicated by the host, when there are no scheduling conflicts. In each scan window, the LL should scan a different advertising channel index. The LL uses all available advertising channel indices.

When performing the passive scanning, the LL only receives packets and does not transmit any packets.

When performing the active scanning, the LL performs listening to rely on advertising PDUs and an advertising PDU type that may request additional information related to the advertising device from the advertising device.

### Initiating State

The LL enters the initiating state by the indication of the host (stack).

When the LL is in the initiating state, the LL performs the listening for the advertising channel indices.

During the initiating state, the LL listens to the advertising channel index during the scan window duration.

### Connection State

The LL enters the connection state when the device performing the connection request, that is, the initiating device, transmits CONNECT_REQ PDU to the advertising device, or when the advertising device receives the CONNECT_REQ PDU from the initiating device.

After entering the connection state, the connection is considered generated. However, there is no need to consider establishing the connection at the time when the connection enters the connection state. The only difference between a newly generated connection and the previously established connection is an LL connection supervision timeout value.

When two devices are connected, the two devices act in different roles.

The LL performing the master role is called a master, and the LL performing the slave role is called a slave. The master controls the timing of the connection event, and the connection event refers to the time when the master and slave are synchronized with each other.

Hereinafter, packets defined in the Bluetooth interface will be briefly described. The BLE devices use packets defined below.

### Packet Format

The LL has only one packet format used for both advertising channel packets and data channel packets.

Each packet is composed of four fields: preamble, access address, PDU, and cyclic redundancy checking (CRC).

When one packet is transmitted on the advertising physical channel, the PDU will be an advertising channel PDU, and when one packet is transmitted on the data physical channel, the PDU will be a data channel PDU.

### Advertising Channel PDU

The advertising channel PDU has a 16-bit header and payloads of various sizes.

A PDU type field of the advertising channel PDU included in the header indicates the PDU type as defined in Table 1 below.

TABLE 1

| PDU Type | Packet Name |
|---|---|
| 0000 | ADV_IND |
| 0001 | ADV_DIRECT_IND |
| 0010 | ADV_NONCONN_IND |
| 0011 | SCAN_REQ |
| 0100 | SCAN_RSP |
| 0101 | CONNECT_REQ |
| 0110 | ADV_SCAN_IND |
| 0111-1111 | Reserved |

### Advertising PDU

The advertising channel PDU types below are called advertising PDUs and used in specific events.

ADV_IND: Connectable non-directional advertising event.

ADV_DIRECT_IND: Connectable directional advertising event.

ADV_NONCONN_IND: Non-directional advertising event not connectable.

ADV_SCAN_IND: Scannable non-directional advertising event.

The PDUs are transmitted in the LL in the advertising state and received by the LL in the scanning state or initiating state.

### Scanning PDU

The advertising channel PDU type below is called a scanning PDU and is used in the conditions described below.

SCAN_REQ: Transmitted by the LL in the scanning state and received by LL in the advertising state.

SCAN RSP: Transmitted by the LL in the advertising state and received by the LL in the scanning state.

### Initiating PDU

The advertising channel PDU type below is called an initiating PDU.

CONNECT_REQ: Transmitted by the LL in the initiating state and received by the LL in the advertising state.

### Data Channel PDU

The data channel PDU has a 16-bit header, a payload of various sizes, and may include a message integrity check (MIC) field.

The procedures, states, packet formats, etc., in the BLE technology disclosed above may be applied to perform the methods proposed in this specification.

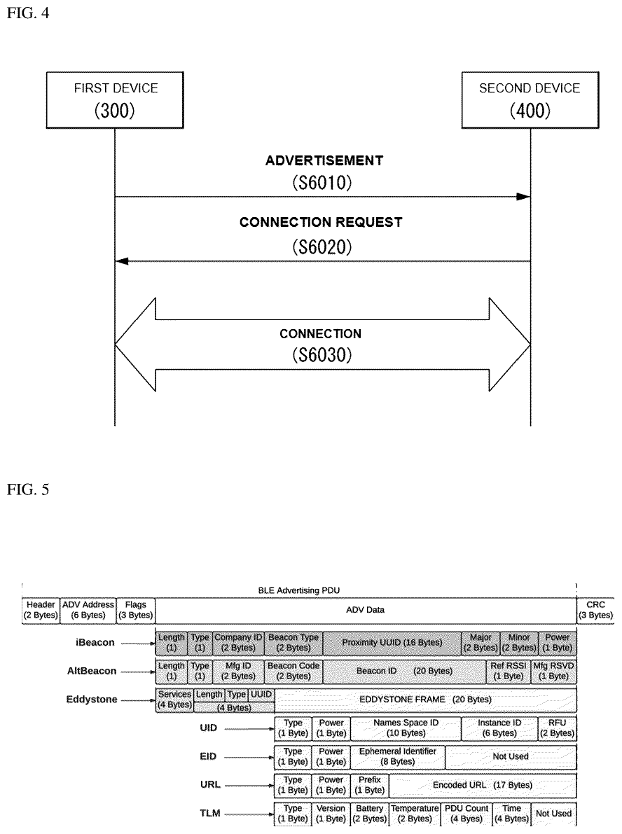

FIG. 4 is a flowchart illustrating a method of forming a connection using BLE between devices.

As illustrated in FIG. 4, for BLE connection between a first device 300 and a second device 400, the first device 300 transmits an advertising message to the second device (S6010).

As disclosed above, the advertising message is used to provide its own information to other devices using the BLE, and may include various types of information such as service information and user information provided by the device.

After confirming the information included in the advertising message transmitted by the first device 300, the second device 400 transmits a connection request message to request a BLE connection to the first device 300 (S6020), and the first device 300 and the second device 400 form the BLE connection (S6030).

FIG. 5 is a diagram illustrating encryption of a beacon protocol that may be applied in the present specification.

FIG. 5 illustrates an example of comparing the existing system for broadcasting BLE advertising data with beacon protocol encryption.
1) iBeacon (Apple)—iBeacon has an advertising packet structure that complies with the Bluetooth 4.0 specification, and may use encryption in an area defined by a user. The iBeacon may be mainly used to transmit beacon signals between devices of Apple.
2) URIBeacon (Known as Eddystone) (Google)—URIBeacon is a form of an Eddystone protocol and may enhance security by utilizing an Ephemeral ID (EID) process. For example, the URIBeacon generates a public key using the Curve25519 algorithm and encrypts the ID by performing AES-128 encryption with an identity key. By encrypting the ID, it is possible to defend attacks that continuously track an ID through RF sniffing.
3) AltBeacon (radius networks)-AltBeacon may support the use of encryption in the user-defined area.

The existing beacon system should go through the BLE connecting procedure for security, and even if the existing beacon system supports encryption, the existing beacon system is often able to encrypt only an ID value. To solve this problem, the method disclosed in this specification is an encryption method of making a length of an original text and the encryption results the same. This makes attacks that traverse data length information difficult.

In addition, a counter (CTR) may be used to prevent the same plain block from producing the same ciphertext.

In addition, a cipher-based message authentication code (CMAC) may be utilized for integrity and authentication of data. By using this, it is possible to detect forgery or falsification of data and secure reliability of data.

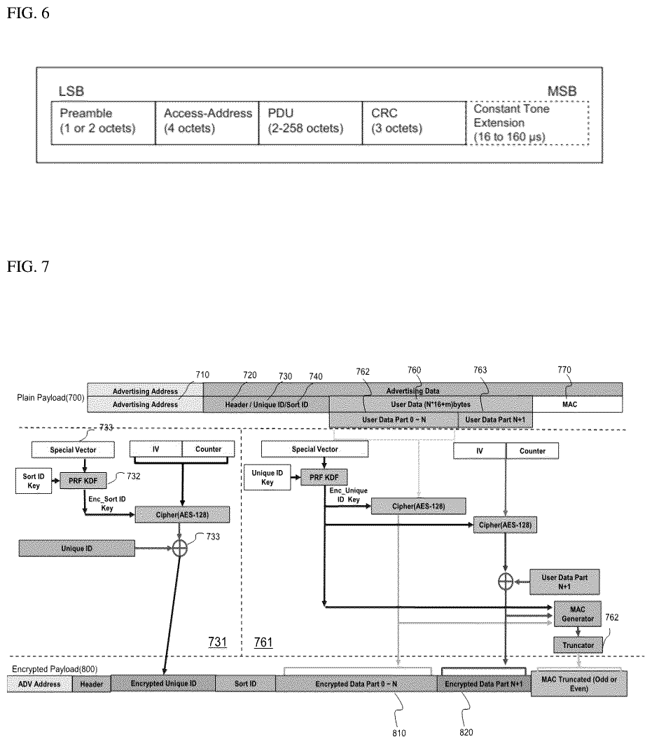

FIG. 6 is a diagram illustrating a packet format of an LE device to which the present specification may be applied.

Referring to FIG. 6, this packet format is defined for LE Uncoded PHY (LE 1M and LE 2M) and may be used for packets of all physical channels.

The packet of the LE device may include the following fields.
(1) Preamble: Bit sequence transmitted at the beginning of a packet, and the preamble may help the receiver to synchronize and detect incoming packets. The length may be 1 octet for LE 1M PHY and 2 octets for LE 2M PHY.
(2) Access Address: 4-octet-sized field, and the access address may be used by the device to distinguish between different connections and identify a destination of a packet.
(3) PDU: This field includes the actual transmitted data. The length may vary from 2 to 258 octets.
(4) CRC: 3-octet-sized field used for error detection and correction. The CRC may help the receiver to identify whether there are errors in the received data.
(5) Constant Tone Extension: Field that may be optionally included in the packet. The duration of this field may vary between 16 and 160 μs, and this field is not always included in the packet.

FIG. 7 is a diagram illustrating a method of securing a data packet that may be applied in the present specification.

Referring to FIG. 7, the wireless device may include the server device 120 and/or the client device 110 and may operate as a beacon.

The data packet may follow the packet format of FIG. 6, and part of the data packet may be encrypted by the wireless device. For example, the data transmitted in the data packet may be composed of manufacturer data, which is a manufacturer data type, and may be a valid advertising data (AD) type. The format of the data packets may comply with the BLE standard. Additionally, the data packet may be used as the advertising packet. Therefore, when using ADV_NONCONN_IND, a length of advertising data (ADV data) may be limited to 31 bytes.

A plain payload 700 of the data packet may include the following elements.
(1) Advertise Address 710: Unique address of the advertising wireless device.
(2) Header 720 indicating ADV Data information: Indicate the type and attribute of advertising data.
(3) Unique ID (730): Unique identifier of the wireless device.
(4) Sort ID 740: ID identifying a specific group.
(5) USER Data (760): User data.

The sort ID 740 is not unique, but can be managed through an index, and there is a different key corresponding to each index, so the unique ID (730) may be encrypted and decrypted.

The lengths of the input plain payload 700 and an output encrypted payload 800 are the same, and the length of the user data 760 may change. For example, in the case of the block encryption, when the encrypted payload 800 is smaller than the block length, the block encryption in the CTR mode may be used to treat the length to be the same as the plain payload 700.

The encryption of the unique ID 730 is performed using a key (sort ID key) indexed by the sort ID 740, and the encrypted unique ID 730 may be prevented from being tracked. The indexed key may be stored in a memory unit (NVM), and the exchanged key is a symmetric key and may require to be shared in advance.

To secure the integrity and user authentication of data, a MAC 770 may be attached. The MAC 770 may use a cipher block chaining message authentication code (CBC-MAC or CMAC), and some encrypted payload 800 may be used through a preset truncator. Truncator results should include a most significant byte (MSB) of an input value.

### Encryption—Unique ID Encryption Method 731

In order to prevent the tracking of the unique ID (manufacture ID) 730, the wireless device may perform encryption so that only mutually authenticated users may recognize the unique ID. For example, passwords for the unique ID 730 may be classified based on the sort ID 740. The encryption key (sort ID key) indexed in the sort ID 740 may be stored in the memory unit.

A derived key pseudorandom, that is, a key derivation function 732, may be used in the indexed encryption key (sort ID key, unique ID key) to prevent key hacking. For example, the output of the key derivation function 732 may be randomized.

In more detail, to protect the indexed encryption key (sort ID Key, unique ID Key) from physical chip hacking attacks such as a side channel attack or external password hacking attacks, a derived key (Enc_Sort/unique ID Key) that has been encrypted once more may be used.

A special vector 733 may be included as an input to the key derivation function 732. For example, the special vector 733 may follow the standard for the key derivation function.

The entire structure of the encryption may be a CTR mode.

When the encryption is performed in the CTR mode, the encryption algorithm (for example, in the case of cipher algorithm) may be advanced encryption standard 128-bit (aes-128). For example, when the encryption is performed in the CTR mode, the input of the cipher function may include an initialization vector (IV) and the CTR, and the output of the cipher function may be a plain (unique ID 730 and exclusive OR (XOR) 733).

For example, the initialization vector (IV) serves to set the initial state of the block in the block cipher. To prevent the attacks that analyze the encrypted data and make the patterning of the block cipher difficult, the IV may be generated differently each time, and the IV may include random or unpredictable values.

### Encryption—Unique ID Encryption Method 761

The unique ID Key may be a unique (symmetric key) value indexed in a unique ID that is indexed in the unique ID 730. The unique ID key value may be stored in the memory unit.

In general block encryption, it is output in a multiple of 16 bytes, so if the length of the user data 760 is not a multiple of 16 (for example, length % 16!=0), the remaining data 763 may use the CTR mode, and thus, the encryption may be performed. When the length value of the user data 760 is “for example, length % 16==0”, the corresponding data 762 may be encrypted in an electronic codebook (ECB) mode.

For example, when the length of the user data 760 is 13 bytes, a 13 byte value 763 may be block-encrypted in the CTR mode. When the length of the user data is 17 bytes, a value for 16 bytes 762 may be block encrypted in the ECB mode, and the remaining 1 byte value 763 may be block encrypted in the CTR mode.

When the length of the user data 760 is 35 bytes, a value for 32 bytes 762 may be block encrypted in the ECB mode, and the remaining 3 byte value 763 may be block encrypted in the CTR mode.

The CTR mode may operate like stream ciphering while using the block encryption. Accordingly, the length of the remaining plain data 763, which is not a multiple of 16, and the length of the encrypted output data 820 may be made the same.

To secure the integrity and user authentication of data, the wireless device may attach the MAC 770. For the MAC function, CMAC (or CBC MAC) may be used, and for the cipher function, the AES-128 function may be used.

The result value of the CMAC (or CBC MAC) may be truncated through a preset truncator function 762.

The output to the truncator may include the MSB of the input.

For example, the input data for the CMAC (or CBC MAC) may be as follows:
(1) key: ENC_UID (unique ID) _KEY
(2) plain data: header|Encrypted UID|sort ID|Encrypted Data part 0˜N |Encrypted Data Part N+1

The combination of each input data may be concatenation.

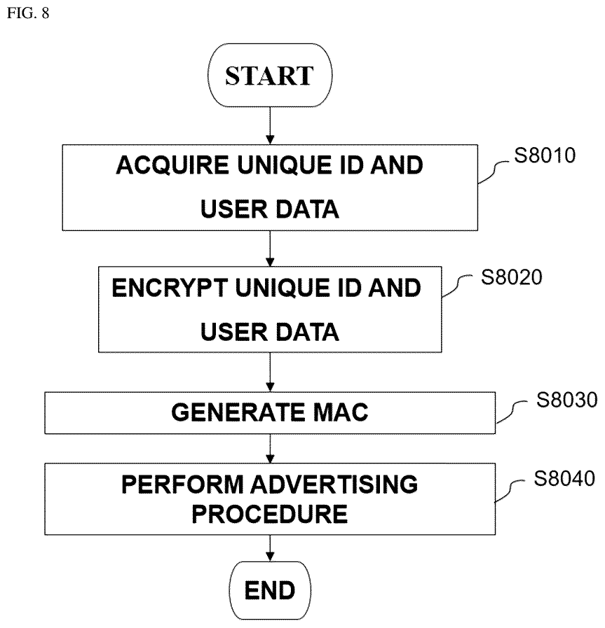

FIG. 8 is a diagram illustrating an embodiment of a wireless device to which the present specification may be applied.

Referring to FIG. 8, the wireless device includes a beacon tag for a client device or advertising device. For example, to perform the advertising procedure using the above-described data packet based on a set interval, the wireless device may repeat a wake-up state and a sleep state.

The wireless device acquires the unique ID and user data (S8010).

For example, the wireless device may be in the wake-up state to perform the advertising procedure. Thereafter, the wireless device may acquire the preset unique ID and user data and use the acquired preset unique ID and user data to generate the plain payload 700.

The data packet may include the plain payload, and the plain text payload may include the advertising address, the header, the unique ID, the sort ID, and the user data.

The wireless device encrypts the unique ID and user data (S8020).

For example, the wireless device may encrypt the unique ID based on the sort ID. To this end, the wireless device may extract the indexed encryption key (Enc_sort ID Key) based on the sort ID. The encryption of the unique ID may be performed through the CTR mode.

The wireless device checks whether the length of the user data is a multiple of 16 bytes, and the user data may be encrypted based on the length of the user data being a multiple of 16 bytes. For example, when the length of the user data is a multiple of 16 bytes, the wireless device may encrypt the user data in the ECB mode based on the unique ID. When the length of the user data is smaller than 16 bytes, the wireless device may encrypt the user data through the CTR mode based on the unique ID.

When the length of the user data is greater than a multiple of 16 bytes, the wireless device divides the user data into a first part having the length value of a multiple of 16 bytes and a second part that is the remaining part, based on a multiple of 16 bytes, and the first part may be encrypted in the ECB mode based on the unique ID and the second part may be encrypted in the CTR mode.

The wireless device generates the MAC (S8030).

For example, the wireless device may generate the truncated MAC based on the header, the encrypted unique ID, the sort ID, and the encrypted user data (first part+second part). The MAC may include the CMAC or CBC MAC.

The wireless device performs the advertising procedure using the encrypted data packet (S8040).

The wireless device may encrypt the data packet based on the encrypted unique ID, the encrypted user data, and the MAC, and perform the advertising process through the encrypted data packet.

When a receiver of such a data packet is a wireless device that plays a bridge role, the wireless device that plays the bridge role does not process the data packet and may directly transmit the data packet to the server for processing the data packet.

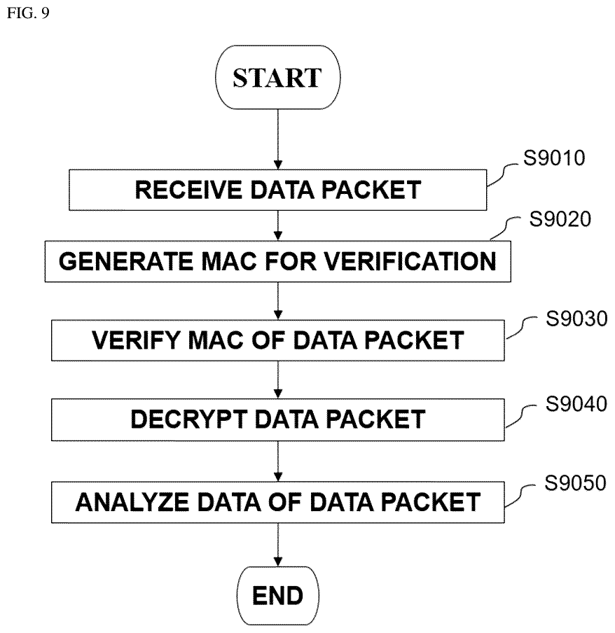

FIG. 9 is an embodiment of a server to which this specification may be applied.

Referring to FIG. 9, the server includes a server device or a beacon reader for receiving advertisements. In addition, the server may include a physical and/or logical configuration for a cloud server. The server may have the listening state for receiving the data packet.

The server receives the encrypted data packet from the wireless device (S9010).

For example, the server may receive the data packet broadcast from the wireless device directly or through the bridge. The encrypted data packet includes the encrypted unique ID, the encrypted user data, and the MAC.

The server generates the MAC for verification of the data packet (S9020).

For example, for the packet integrity and user authentication of data, the server may generate the MAC for verification of the data packet. The server generates the truncated MAC based on the header of the data packet, the encrypted unique ID, the sort ID, and the encrypted user data.

The server verifies the MAC of the data packet (S9030).

For example, the server compares the generated MAC with the MAC of the received data packet to check if the generated MAC and the MAC of the received data packet are the same. When the MACs are different, the server may determine that integrity or authentication is damaged.

When the verification is valid, the server decrypts the data packet (S9040).

For example, the server may decrypt the encrypted unique ID and the encrypted user data. To decrypt the encrypted unique ID, the server may search for the sort ID key value indexed in the received sort ID and decrypt the encrypted unique ID based on the sort ID key.

In addition, the server may decrypt the received encrypted user data using the indexed unique ID key value.

The server analyzes the data of the decrypted data packet (S9050).

The user data in the analyzed data packet may include information that the wireless device wishes to provide.

The existing BLE advertising system does not have password part or is focused on preventing beacon ID tracking, so in order to encrypt data, the encryption is supported only through the connecting procedure. The encryption method disclosed in this specification does not require the connecting procedure, enabling a short latency effect, enhanced personal information protection, and guaranteed data integrity.

In addition, a variety of applications can be implemented, and since a processor is not required, it may be suitable for low-power IoT devices. In addition, it may be applied to the systems without batteries or the devices with long lifetime.

The above-described data packet encryption method may be applied even when the data packet is the extension advertising packet.

In the embodiments described hereinabove, components and features of the present specification are combined with each other in a predetermined form. It is to be considered that the respective components or features are selective unless separately explicitly mentioned. The respective components or features may be implemented in a form in which they are not combined with other components or features. In addition, some components and/or features may be combined with each other to configure the embodiment of the present specification. A sequence of operations described in the embodiments of the present specification may be changed. Some components or features of any embodiment may be included in another embodiment or be replaced by corresponding components or features of another embodiment. It is obvious that claims that do not have an explicitly referred relationship in the claims may be combined with each other to configure an embodiment or be included in new claims by amendment after application.

Embodiments of the present specification may be implemented by various means, for example, hardware, firmware, software, or a combination thereof, and the like. In a case in which an embodiment of the present specification is implemented by the hardware, it may be implemented by one or more application specific integrated circuits (ASICs), digital signal processors (DSPs), digital signal processing devices (DSPDs), programmable logic devices (PLDs), field programmable gate arrays (FPGAs), processors, controllers, microcontrollers, microprocessors, or the like.

In a case in which an embodiment of the present specification is implemented by the firmware or the software, it may be implemented in a form of a module, a procedure, a function, or the like, performing the functions or the operations described above. A software code may be stored in a memory and be driven by a processor. The memory may be positioned inside or outside the processor and transmit and receive data to and from the processor by various well-known means.

According to an embodiment of the present specification, it is possible to encrypt an advertising packet without a BLE connecting procedure.

Effects which can be achieved by the present specification are not limited to the above-described effects. That is, other objects that are not described may be obviously understood by those skilled in the art to which the present specification pertains from the following description.

It is obvious to those skilled in the art that the present specification may be embodied in another specific form without departing from the essential feature of the present specification. Therefore, the above-mentioned detailed description is to be interpreted as being illustrative rather than being restrictive in all aspects. The scope of the present specification is to be determined by reasonable interpretation of the claims, and all modifications within an equivalent range of the present specification fall in the scope of the present specification.

What is claimed is:

1. A method of encrypting, by a wireless device, a data packet in advertising broadcast communication for Bluetooth low energy (BLE), the method comprising:
acquiring a preset unique identifier (ID) and user data, the data packet including an advertising address, a header, the unique ID, a sort ID, and the user data;
encrypting the unique ID and the user data;
generating a message authentication code (MAC); and
generating an encrypted data packet, the encrypted data packet including the encrypted unique ID, the encrypted user data, and the MAC.

2. The method of claim 1, wherein the encrypting of the unique ID and the user data includes:
extracting an indexed encryption key based on the sort ID; and
encrypting the unique ID based on the indexed encryption key.

3. The method of claim 2, wherein the encrypting of the unique ID is performed using a counter (CTR) mode.

4. The method of claim 1, wherein the encrypting of the unique ID and the user data includes:
inspecting whether a length of the user data is a multiple of 16 bytes; and
encrypting the user data based on the inspection.

5. The method of claim 4, wherein, in the encrypting of the user data based on the inspection, when the length of the user data is a multiple of 16 bytes, the user data is encrypted using an electronic codebook (ECB) mode based on the unique ID.

6. The method of claim 4, wherein, in the encrypting of the user data based on the inspection, when the length of the user data is smaller than 16 bytes, the user data is encrypted using a counter (CTR) mode based on the unique ID.

7. The method of claim 4, wherein the encrypting of the user data based on the inspection includes:
dividing the user data into a first part having a length value that is a multiple of 16 bytes and a second part that is a remaining part when the length of the user data is greater than a multiple of 16 bytes;
encrypting the first part using an electronic codebook (ECB) mode based on the unique ID; and
encrypting the second part using a counter (CTR) mode based on the unique ID.

8. The method of claim 7, wherein, in the generating of the MAC is generated based on the header, the MAC is generated based on the header, the encrypted unique ID, the sort ID, the encrypted first part, and the encrypted second part.

9. The method of claim 1, further comprising performing the advertising broadcast communication for BLE using the encrypted data packet.

10. A wireless device for encrypting a data packet in advertising broadcast communication for Bluetooth low energy (BLE), the wireless device comprising:
a memory; and
a processor that controls the memory,
wherein the processor acquires a preset unique identifier (ID) and user data from the memory, the data packet including an advertising address, a header, a unique ID, a sort ID, and the user data, encrypts the unique ID and the user data, generates a message authentication code (MAC), and generates an encrypted data packet that includes the encrypted unique ID, the encrypted user data, and the MAC.

11. A method of decrypting, by a server, an encrypted data packet in advertising broadcast communication for Bluetooth low energy (BLE), the method comprising:
receiving the encrypted data packet, the encrypted data packet including an encrypted unique ID, encrypted user data, and a message authentication code (MAC);
verifying the MAC; and
decrypting the data packet based on a fact that the MAC is valid.
